(19) United States
(12) Patent Application Publication
(10) Pub. No.: US 2008/0120301 A1
(43) Pub. Date: May 22, 2008

(54) METHOD AND SYSTEM FOR USING DATA PROFILES OF DATABASE TABLES TO IDENTIFY POTENTIAL BUGS IN BUSINESS SOFTWARE

(76) Inventor: Ori Pomerantz, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/560,946

(22) Filed: Nov. 17, 2006

(51) Int. Cl. G06F 7/00

(52) U.S. Cl. 707/9; 707/E17.005

(57) ABSTRACT

A method, system, apparatus, or computer program product is presented for processing data from a database to derive a database examination profile that is then subsequently evaluated against the database in order to discover potential software bugs in an application program that uses the database. After a database has been used to store data, the data within the database is analyzed to derive a set of columnar constraint functions that represent constraints between values in different columns of the database. The set of columnar constraint functions are then stored in the data processing system in a data structure that represents a database examination profile. At some subsequent point in time, the database examination profile is employed to examine data that is currently stored within the database. The columnar constraint functions are applied against the rows of the database, and any violations of columnar constraints are reported as potential data anomalies.

### BACKGROUND OF THE INVENTION

1. Field of the Invention

The present invention relates to an improved data processing system and, in particular, to a method and apparatus for database processing.

2. Description of Related Art

Most application programs rely upon database software to persistently store large amounts of data. Typically, an application program sends or receives data through a well-defined software interface, and a database engine stores or retrieves data from tables within the database. An application program that relies upon the database software can assume that the database software is reliable and bug-free, thereby relieving the application programmer from writing specialized source code for generating a datastore for each new application program.

However, an application programmer may create software bugs within the source code of an application program that employs database software. The database software typically has functionality for checking for certain types of errors, thereby flagging some errors. For example, the database software may flag some errors during runtime, and the application programmer would be alerted to those errors, thereby enabling the application programmer to correct certain types of bugs in the source code of the application program. However, the database software may not catch all errors, thereby allowing the application program to continue to operate with unknown bugs, which could eventually generate anomalies in the stored data within a database. In some cases, these errors can be difficult to discover and can result in errors that are difficult to understand at some later point in time when the database is accessed by other application programs.

Therefore, it would be advantageous to improve database software to identify potential bugs in application programs that employ the database software.

### SUMMARY OF THE INVENTION

A method, system, apparatus, or computer program product is presented for processing data from a database to derive a database examination profile that is then subsequently evaluated against the database in order to discover potential software bugs in an application program that uses the database. After a database has been used to store data, the data within the database is analyzed to derive a set of columnar constraint functions that represent constraints between values in different columns of the database. The set of columnar constraint functions are then stored in the data processing system in a data structure that represents a database examination profile. At some subsequent point in time, the database examination profile is employed to examine data that is currently stored within the database. The columnar constraint functions are applied against the rows of the database, and any violations of columnar constraints are reported as potential data anomalies.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIGS. 2A-2B depict block diagrams that show some of the functional units into which a computational environment may be organized to include columnar-constrained database examination functionality;

FIG. 3 depicts a flowchart that shows some of the temporal phases for employing the database examination functionality of the present invention with respect to a given database;

FIG. 4 depicts a flowchart that shows a process for generating a database examination profile having a set of columnar constraint functions for a given database FIG. 5 depicts a flowchart that shows a process for applying columnar constraint functions from a database examination profile against a database in order to detect data anomalies;

FIG. 6A depicts an exemplary database table, wherein the represented database table is analyzed to derive a set of columnar constraint functions for a database examination profile; and

FIG. 6B depicts an exemplary database table, wherein the represented database table is examined using a previously derived set of columnar constraint functions from a database examination profile.

### DETAILED DESCRIPTION OF THE INVENTION

In general, the devices that may comprise or relate to the present invention include a wide variety of data processing technology. Therefore, as background, a typical organization of hardware and software components within a data processing system is described prior to describing the present invention in more detail.

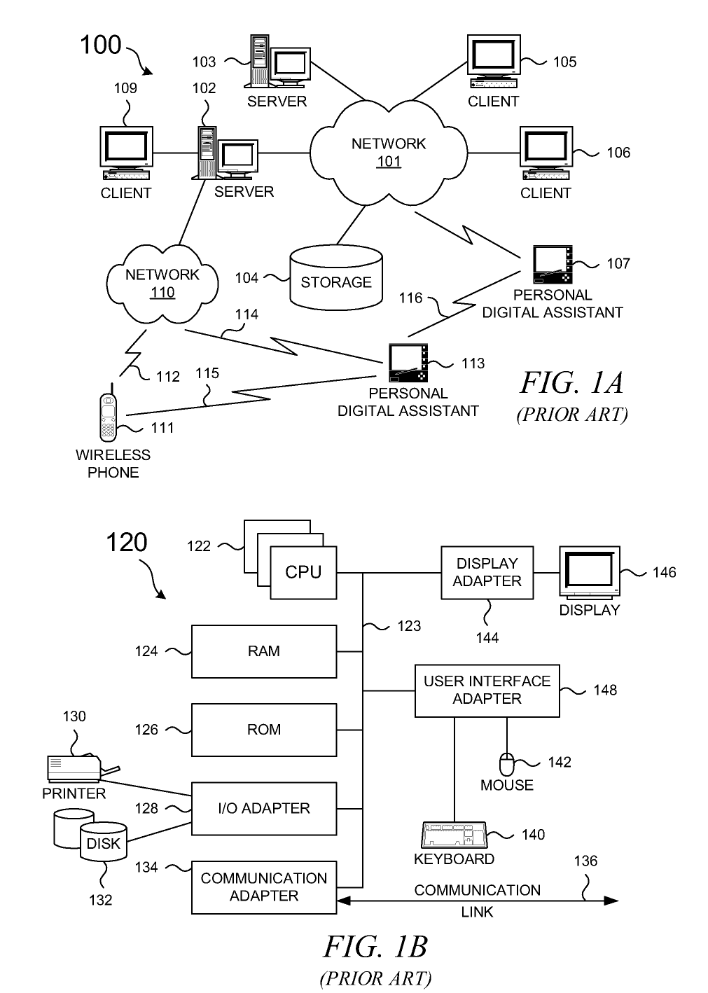

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), File Transfer Protocol (FTP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. The present invention may also be used with respect to distributed applications and distributed databases that are located throughout a network. More specifically, though, the present invention is directed to an improved method for detecting bugs in application programs that employ database software by performing a process of database examination, as described in more detail below with respect to the remaining figures.

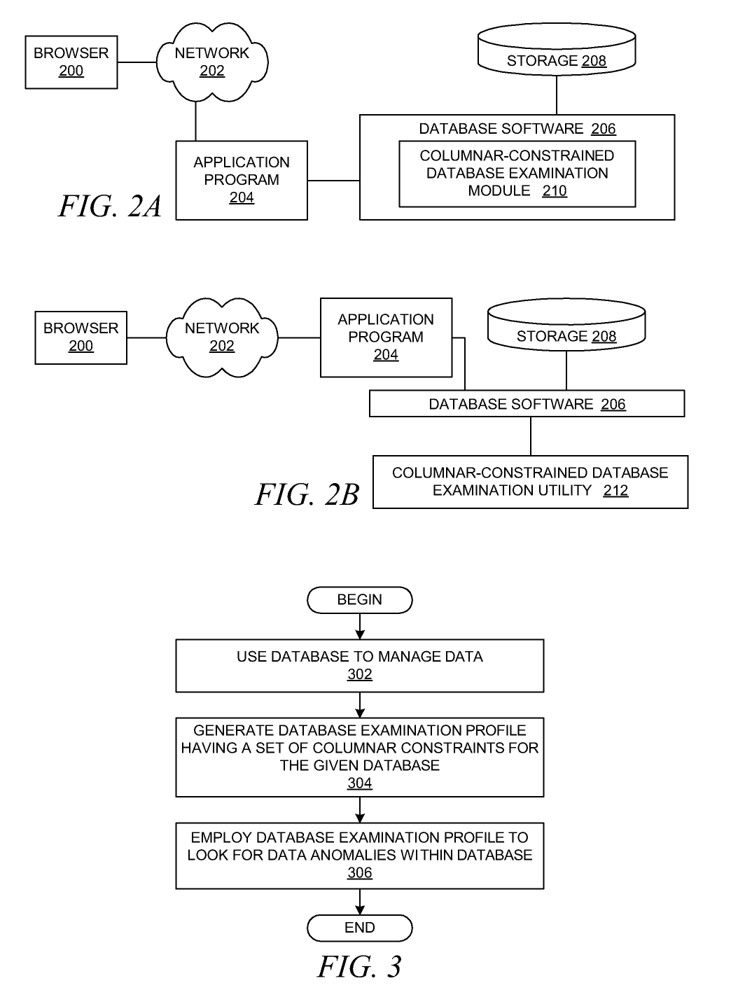

With reference now to FIGS. 2A-2B, block diagrams depict some of the functional units into which a computational environment may be organized in accordance with an embodiment of the present invention. Although many new applications are written to perform user interaction through a browser-based interface, as shown in FIGS. 2A-2B, the present invention is not limited to such implementations. However, in the examples that are shown in FIGS. 2A-2B, a user accesses protected resources, such as server applications that might perform an e-commerce transaction for the user, through browser application 200, which communicates through network 202 with server application program 204. Server application program 204 employs database software 206 to manage persistent datastore 208, e.g., which might contain e-commerce transaction data. The present invention is directed to functionality that examines database tables for data anomalies using columnar constraint functions. The form factor of the functionality of the present invention may vary in different implementations. In one implementation of the present invention, referring to FIG. 2A, database software 206 includes columnar-constrained database examination module 210, thereby embedding the functionality of the present invention within the database software. In a different implementation of the present invention, referring to FIG. 2B, columnar-constrained database examination utility 212 is a free-standing program that a programmer analyst may use to examine the data within datastore 208 without a requirement to modify database software 206 to incorporate the functionality of the present invention.

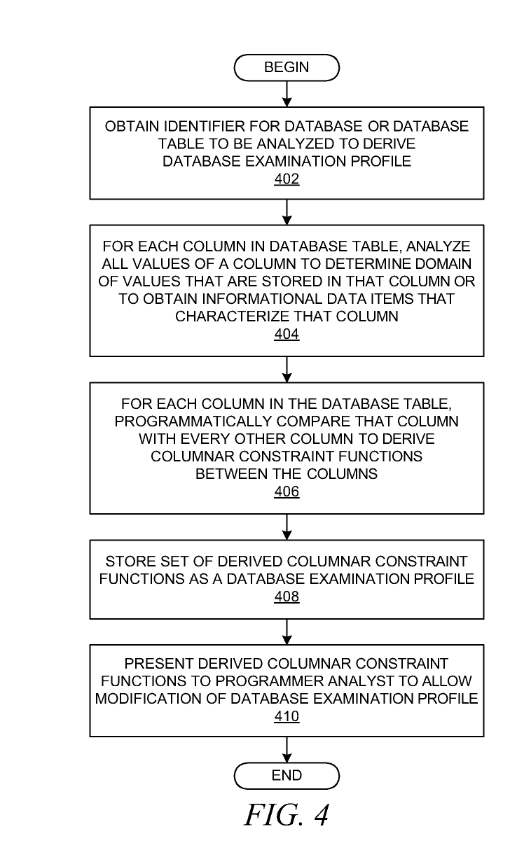

With reference now to FIG. 3, a flowchart depicts some of the temporal phases for employing the database examination functionality of the present invention with respect to a given database. In a first phase, the database is used to manage data in a typical fashion (step 302), e.g., by storing and retrieving data to/from the database by one or more application programs, typically with assistance from a front-end database engine or database software.

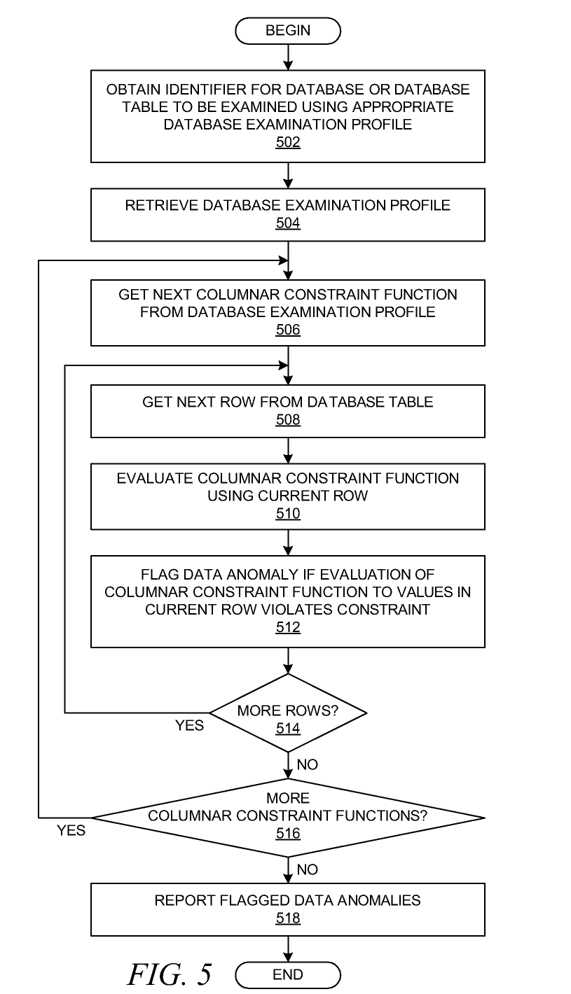

At some point in time after usage of the database, the database contains significant amounts of data and possibly also contains some data anomalies which the functionality of the present invention can attempt to discover. Hence, during a second phase, a database examination profile is generated (step 304) by creating a set of one or more columnar constraint functions by scanning the stored data within the database, as described in more detail in FIG. 4. In different embodiments, the database may or may not continue to be used while the database examination profile is generated. It should also be noted that multiple database examination profiles may be generated from a single database; for example, different sets of columnar constraint functions may be created from a single database, particular upon the judgment of a programmer analyst who adjusts or modifies a database examination profile. Also, multiple different database examination profiles may be applicable to a single instance of the database, or the multiple different database examination profiles may be used against multiple instances of the database. In other words, a database schema does not imply the existence of a unique database examination profile. Hence, the second phase at step 304 can be repeated when necessary to create a database examination profile.

At some point in time after the database examination profile is created, the given database may continue to be used, or a new instance of the database is created and used. During a third phase, the database is examined by applying the columnar constraint functions from an applicable database examination profile to the data in the database in an attempt to discover data anomalies (step 306), thereby concluding the process of three phases as shown in FIG. 3. By reporting any data anomalies that are found, there is a possibility that potential software bugs have also been discovered within one or more application programs that have stored data into the database. It should be noted that the difficulty of finding potential bugs in application programs that have employed the database is significantly reduced when only one application program has employed the database. Any database examination profile is applicable against a given instance of a database if the database examination profile was generated by examining an instance of the database. Again, in different embodiments, the database may or may not continue to be used while the database examination profile is applied against the database. Hence, the third phase at step 306 can be repeated when necessary to apply a database examination profile against a database.

With reference now to FIG. 4, a flowchart depicts a process for generating a database examination profile having a set of columnar constraint functions for a given database in accordance with an embodiment of the present invention. The process commences by obtaining an identifier for, or a reference to, an instance of a database (step 402) that is to be analyzed to generate a database examination profile. In this example, the database may be assumed to represent a simple case in which the database contains a single relational table; in other scenarios, the database examination profile may be generated by processing multiple database tables or even multiple databases, depending on the accounting and/or management of the identifiers for those database tables and the manner in which the database tables are used.

For each column in the database table, all of the values of a column are analyzed to determine the domain of values that are stored in that column (step 404). This step may be assisted by referencing a database schema that indicates the data type of the values that are stored within the column. Alternatively, the data types may be encoded within the database such that the data types can be obtained through SQL commands that allow a query of the data type. After analyzing the domain of values in the column, various informational data items about the domain of values may be stored, such as the maximum value, the minimum value, the average value, the value that appears most frequently, the value that appears least frequently, or other informational data items; this set of informational data items provides a characterization of the typical values that are to be found within the column.

For each column in the database table, a column is programmatically compared with every other column to derive columnar constraint functions between the columns (step 406). For example, the informational data items that characterize a column are compared with the informational data items that characterize another column; relationships between the values in the columns are derived. Various mathematical equalities, inequalities, or logical functions can be used to compare the columnar values or the informational data items that characterize the columns. In one embodiment, various types of data mining techniques may be used to determine relevant relationships and associations between the columnar values. When a relevant relationship is programmatically derived, the relationship is cast as a columnar constraint function between the two columns, e.g., by deriving parameters for the columnar constraint function, such as identifiers for the columns that have been compared, an identifier for the type of function that has been determined to be relevant, and various parameters for the function that guide the operation of the function when it is applied at some later point in time to evaluate the values in a given row of a table during the database examination phase.

After the columnar constraint functions have been derived, the parameters for the columnar constraint functions are stored in a file or other data structure as a database examination profile (step 408). These parameters can be stored in a variety of formats, either in a binary, programmatic fashion or in a human-readable fashion, e.g., as an XML-formatted file.

The database examination profile can be optionally presented and adjusted or otherwise modified by a programmer analyst through an appropriate user interface or by editing a file that contains the database examination profile (step 410), thereby allowing a programmer analyst to fine-tune the set of columnar constraint functions. This optional step allows a programmer analyst to delete various derived columnar constraint functions that are determined to be irrelevant or nonsensical; the programmer analyst can also adjust or even create columnar constraint functions.

After the set of columnar constraint functions are stored in a file or other data structure as a database examination profile, the database examination profile is maintained until it is used to examine a database for data anomalies during a later period of time, e.g., as described above with respect to FIG. 3 and as described in more detail below with respect to FIG. 5.

With reference now to FIG. 5, a flowchart depicts a process for applying columnar constraint functions from a database examination profile against a database in order to detect data anomalies in accordance with an embodiment of the present invention. The process commences by obtaining an identifier of a database or database table that is to be examined using an appropriate database examination profile that contains a set of one or more columnar constraint functions (step 502). Again, in this example, the database may be assumed to represent a simple case in which the database contains a single relational table.

A database examination profile is retrieved based on the given identifier for the database or database table (step 504). An appropriate database examination profile may be determined by using the given database identifier as a search key within a lookup table to obtain a reference, e.g., a filename or pointer, to a stored database examination profile. In one embodiment, a programmer analyst may be able to select from a variety of appropriate database examination profiles.

Each of the columnar constraint functions within the database examination profile are then applied to the database table of interest by iterating through the set of columnar constraint functions. Hence, the next columnar constraint function is read from the selected database examination profile (step 506). In one embodiment, various parameters that characterize a columnar constraint function are retrieved from the database examination profile and are used as input values to a programmatically defined constraint function; for example, two of the parameters may indicate the two columns whose values in the current row are to be compared, wherein other inputs to the programmatically defined constraint function would include the values that are stored within the current row.

For each columnar constraint function that is applied to the database table of interest, a columnar constraint function is evaluated against each row of the database table of interest. Hence, the next row in the database table is retrieved (step 508), and the current columnar constraint function is evaluated against the values in the current row (step 510). If the application of the current columnar constraint function against the current row violates the columnar constraint, i.e. if the values in the current row do not adhere to the constraint relationship that is defined by the current columnar constraint function, then a data anomaly is flagged (step 512).

After evaluating the current row, a determination is made as to whether or not there is another row in the database table that has not yet been evaluated using the current columnar constraint function (step 514); if so, then the process branches back to step 508 to process another row. If there are no more rows to be evaluated against the current columnar constraint function, then the process continues by determining whether or not there is another columnar constraint function within the database examination profile that has not been applied against the database table (step 516); if so, then the process branches back to step 506 to obtain the next columnar constraint function. If there are no more columnar constraint functions within the database examination profile, i.e. all columnar constraint functions have been applied against the database table, then the process reports all flagged data anomalies (step 518), thereby concluding the processing.

The manner in which the flagged data anomalies are reported may vary in different implementations of the present invention. By generating a file or an error message or by creating a record within a log file, a programmer analyst is alerted to the existence of the data anomaly, thereby allowing a programmer analyst to determine whether or not the data anomaly has been created by a potential software bug in an application program that has stored data into the database table that was examined by evaluating the columnar constraint functions in the database examination profile. The programmer analyst may then take steps to debug the application program or to verify that the data anomaly was not created by the application program.

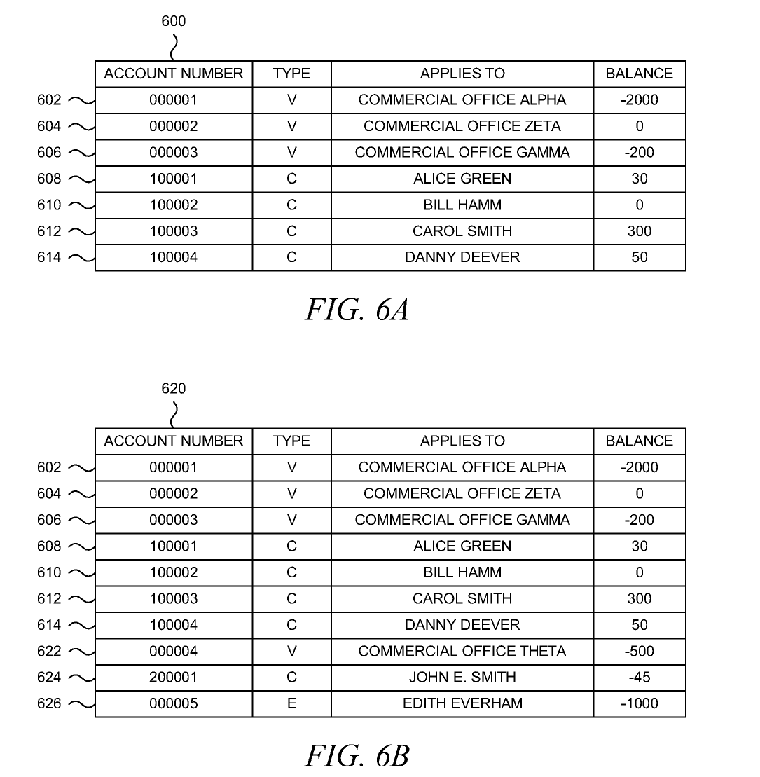

With reference now to FIG. 6A, an exemplary database table is shown, wherein the represented database table is analyzed to derive a set of columnar constraint functions for a database examination profile. Rows 602-614 of table 600 are analyzed using the analysis process that is described with respect to FIG. 4. In this example, the analysis process may determine that the “Account Number” column always contains a six digit value and that the “Type” column always contains the enumerated-type values of either “C” or “V”.

The analysis process may further derive the following columnar constraint functions:

for “V” type accounts, the value of the “Balance” column is always negative or zero;

for “C” type accounts, the value of the “Balance” column is always positive or zero;

for “C” type accounts, the “Applies To” column is always two words;

for “V” type accounts, the “Account Number” column is always in the range of values of 000001-000003;

for “C” type accounts, the “Account Number column is always in the range of values of 100001-100004.

Some of these relationships may be known; moreover, some of these relationships may be an artifact of the logic within an application program, e.g., the application program only creates account types that are enumerated as “V” or “C”. Other constraints might be unknown to an application programmer when the application program is created, e.g., that vendors have “V” type accounts that have either negative or zero balances based on whether or not the operator/owner of the database owes money to the vendors; likewise, customers have “C” type accounts that have either positive or zero balances based on whether or not the customers owe money to the operator/owner of the database.

Other columnar constraint functions may be too restrictive and would be noticed by a programmer analyst, e.g., the constraints on the range of values for the account numbers, which would be immediately violated upon adding a new account and incrementing to the next higher account number. Overly restrictive constraints might be deleted or adjusted by a programmer analyst, e.g., by modifying the range of values on the customer account numbers to be greater, such as 100001-199999. It should be noted that overly restrictive columnar constraints are not necessarily problematic as the present invention is intended as an alerting mechanism for finding potential bugs and not a failure-avoidance mechanism that must prevent the appearance of data anomalies or that must autonomically correct any potentially discovered bugs.

With reference now to FIG. 6B, an exemplary database table is shown, wherein the represented database table is examined using a previously derived set of columnar constraint functions from a database examination profile. Table 620 in FIG. 6B is similar to table 600 in FIG. 6A except that table 620 in FIG. 6B has been modified by adding rows 622-626 to rows 602-614.

Table 620 is examined by using the examination process that is described with respect to FIG. 5, and several data anomalies would be flagged based on the columnar constraint functions that were derived from table 600 in FIG. 5.

Row 622 would be flagged as having a potential data anomaly. Although row 622 seems to be a legitimate entry, the vendor account number constraint of range 000001-000003 has been violated; since vendor account numbers might be allowed to range from 000001-099999, a programmer analyst can change the columnar constraint function in response to reviewing this data anomaly.

Row 624 would be flagged as having two potential data anomalies. Row 624 seems to be an illegitimate entry as customer account numbers should be contained within the range from 100001-199999. In response to reviewing this data anomaly, a programmer analyst may decide that an application program has a potential software bug. However, with respect to the second data anomaly for this row, row 624 has apparently violated the columnar constraint function that the “Applies To” column can only have two words. Upon reflection, the programmer analyst decides that customers should be allowed to specify a middle name or middle initial; hence, the programmer analyst decides to change the columnar constraint function in response to the second reported data anomaly for this row.

Row 626 would be flagged as having a potential data anomaly. Row 626 seems to be an illegitimate entry as there is no account type of “E”. In response to reviewing this data anomaly, a programmer analyst may decide that an application program has a potential software bug.

The advantages of the present invention should be apparent in view of the detailed description that is provided above. Data within a database are analyzed to derive columnar constraint functions that are subsequently evaluated against the data within the database. Any potential data anomalies that are found during evaluation by violation of the columnar constraints are reported, and the potential data anomalies can be reviewed by a programmer analyst to determine whether or not a potential software bug exists within an application program such that the potential software bug may have generated the data anomaly.

Moreover, by applying columnar constraint functions, either during runtime or between runtime periods, to a database after data has been stored within the database, application programs can continue to use the database without a loss of functionality. The present invention merely generates alerts to potential software bugs as reflected by potential data anomalies; although the present invention may generate false positives in the form of illegitimate alerts, a computational environment can be configured such that these false alerts do not necessarily impinge on the continued processing of ongoing or subsequent transactions. Moreover, false positives can be corrected by modifying the columnar constraint functions within the database examination profile without any attempt to debug the application program.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

Certain computational tasks may be described as being performed by functional units. A functional unit may be represented by a routine, a subroutine, a process, a subprocess, a procedure, a function, a method, an object-oriented object, a software module, an applet, a plug-in, an ActiveX™ control, a script, or some other component of firmware or software for performing a computational task. The descriptions of elements within the figures may involve certain actions by either a client device or a user of the client device. One of ordinary skill in the art would understand that requests and/or responses to/from a client device are sometimes initiated by a user and at other times are initiated automatically by a client, often on behalf of a user of the client. Hence, when a client or a user of a client is mentioned in the description of the figures, it should be understood that the terms “client” and “user” can often be used interchangeably without significantly affecting the meaning of the described processes.

The descriptions of the figures herein may involve an exchange of information between various components, and the exchange of information may be described as being implemented via an exchange of messages, e.g., a request message followed by a response message. It should be noted that, when appropriate, an exchange of information between computational components, which may include a synchronous or asynchronous request/response exchange, may be implemented equivalently via a variety of data exchange mechanisms, such as messages, method calls, remote procedure calls, event signaling, or other mechanism.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing data in a database within a data processing system, the method comprising the steps of:
using the database to manage data;
deriving, based on managed data within the database, a set of columnar constraint functions that represent constraints between values in different columns of the database; and
storing the set of columnar constraint functions in the data processing system in a data structure that represents a database examination profile.

2. The method of claim 1 further comprising:
comparing values in a first column of the database with values in a second column of the database in order to derive a columnar constraint function between the first column and the second column.

3. The method of claim 1 further comprising:
presenting derived columnar constraint functions to a user; and
accepting input from the user to modify or to delete a derived columnar constraint function.

4. The method of claim 1 further comprising:
retrieving the database examination profile;
employing the database examination profile to examine data that is stored within the database; and
reporting potential data anomalies in accordance with results of examining the data that is stored within the database using the database examination profile.

5. The method of claim 4 further comprising:
retrieving a columnar constraint function from the database examination profile;
evaluating the retrieved columnar constraint function against a row of the database using at least two row values as inputs to the retrieved columnar constraint function; and
identifying a potential data anomaly if a columnar constraint that is represented by the evaluated columnar constraint function is violated.

6. The method of claim 4 further comprising:
presenting reported potential data anomalies to a user; and
accepting input from the user to indicate that a reported potential data anomaly represents a potential software bug in an application program that has stored data within the database.

7. A computer program product on a computer-readable medium for processing data in a database within a data processing system, the computer program product comprising:
means for using the database to manage data;
means for deriving, based on managed data within the database, a set of columnar constraint functions that represent constraints between values in different columns of the database; and
means for storing the set of columnar constraint functions in the data processing system in a data structure that represents a database examination profile.

8. The computer program product of claim 7 further comprising:
means for comparing values in a first column of the database with values in a second column of the database in order to derive a columnar constraint function between the first column and the second column.

9. The computer program product of claim 7 further comprising:
means for presenting derived columnar constraint functions to a user; and
means for accepting input from the user to modify or to delete a derived columnar constraint function.

10. The computer program product of claim 7 further comprising:
means for retrieving the database examination profile;
means for employing the database examination profile to examine data that is stored within the database; and
means for reporting potential data anomalies in accordance with results of examining the data that is stored within the database using the database examination profile.

11. The computer program product of claim 10 further comprising:
means for retrieving a columnar constraint function from the database examination profile;
means for evaluating the retrieved columnar constraint function against a row of the database using at least two row values as inputs to the retrieved columnar constraint function; and
means for identifying a potential data anomaly if a columnar constraint that is represented by the evaluated columnar constraint function is violated.

12. The computer program product of claim 10 further comprising:
means for presenting reported potential data anomalies to a user; and
means for accepting input from the user to indicate that a reported potential data anomaly represents a potential software bug in an application program that has stored data within the database.

13. An apparatus for processing data in a database within a data processing system, the apparatus comprising:
means for using the database to manage data;
means for deriving, based on managed data within the database, a set of columnar constraint functions that represent constraints between values in different columns of the database; and
means for storing the set of columnar constraint functions in the data processing system in a data structure that represents a database examination profile.

14. The apparatus of claim 13 further comprising:
means for comparing values in a first column of the database with values in a second column of the database in order to derive a columnar constraint function between the first column and the second column.

15. The apparatus of claim 13 further comprising:
means for presenting derived columnar constraint functions to a user; and
means for accepting input from the user to modify or to delete a derived columnar constraint function.

16. The apparatus of claim 13 further comprising:
means for retrieving the database examination profile;
means for employing the database examination profile to examine data that is stored within the database; and
means for reporting potential data anomalies in accordance with results of examining the data that is stored within the database using the database examination profile.

17. The apparatus of claim 16 further comprising:
means for retrieving a columnar constraint function from the database examination profile;
means for evaluating the retrieved columnar constraint function against a row of the database using at least two row values as inputs to the retrieved columnar constraint function; and
means for identifying a potential data anomaly if a columnar constraint that is represented by the evaluated columnar constraint function is violated.

18. The apparatus of claim 16 further comprising:
means for presenting reported potential data anomalies to a user; and
means for accepting input from the user to indicate that a reported potential data anomaly represents a potential software bug in an application program that has stored data within the database.
